(19) United States
(12) Patent Application Publication
(10) Pub. No.: US 2023/0097436 A1
(43) Pub. Date: Mar. 30, 2023

(54) Method For Producing An Aromatic Diether And Corresponding Methods For Producing Polyaryl Ether Ketones

(71) Applicant: ARKEMA FRANCE, Colombes (FR)

(72) Inventors: Philippe BUSSI, Colombes Cedex (FR); Guillaume LE, Serquigny (FR); Anne-Claude GAUMONT, Caen Cedex (FR); Hashim ALBADRI, Caen Cedex (FR)

(73) Assignee: ARKEMA FRANCE, Colombes (FR)

(21) Appl. No.: 17/786,044

(22) PCT Filed: Dec. 18, 2020
(86) PCT No.: PCT/FR2020/052563

§ 371 Date: Jun. 16, 2022

(30) Foreign Application Priority Data
Dec. 20, 2019 (FR) FR1915347

(51) Int. Cl. C08G 61/12; C08G 65/40

(52) U.S. Cl. CPC C08G 61/127; C08G 65/4012; C08G 2261/3442; C08G 2650/40

(57) ABSTRACT

A process for manufacturing an aromatic diether, including the reaction of a compound A including at least two halogenated aromatic groups with a compound B, B being an aromatic alkoxide, optionally in the presence of a compound C acting as reaction solvent, the molar proportion of compound B to compound A being at least 2:1 and the molar amount of compound C to compound A being, where appropriate, not more than 10:1. Also, a process for manufacturing a polyaryl ether ketone.

### TECHNICAL FIELD

The invention relates to a process for manufacturing aromatic diether(s).

The invention also relates to a process for manufacturing polyaryl ether ketones from at least some of these aromatic diethers.

### PRIOR ART

Various industrial processes for manufacturing polyaryl ether ketones, such as polyether ether ketones, polyether ketone ketones, or copolymers of polyether ether ketones and of polyether diphenyl ether ketones, are known from the prior art.

A first known route for manufacturing polyaryl ether ketone polymers is based on a nucleophilic substitution and was described, for example, in WO 86/07599.

The process consists of the polycondensation of a difluoro monomer with a monomer comprising two phenol functions in a solvent, for example diphenyl sulfone, at elevated temperatures (between 280° C. and 320° C.).

A second known route is based on an electrophilic substitution reaction between aromatic acid chlorides and aromatic ethers in the presence of a Lewis acid, and has been described, for example, in U.S. Pat. No. 4,816,556. In particular, the process for manufacturing polyether ketone ketones may be based on diphenyl ether, or alternatively on 1,4-bis(4-phenoxybenzoyl)benzene, as the starting monomer for the polymerization reaction. In U.S. Pat. No. 4,816,556, 1,4-bis(4-phenoxybenzoylbenzene) was synthesized by electrophilic substitution between terephthaloyl chloride and excess diphenyl ether in the presence of aluminum trichloride (Lewis acid) in ortho-dichlorobenzene (solvent).

Ke, Y. et al. (1998), Investigations of the practical routes, structure, and properties for poly(aryl ether ketone ketone) polymers. J. Appl. Polym. Sci., 67: 659-677. doi:10.1002/(SICI)1097-4628(19980124)67:4<659::AID-APP9>3.0.CO; 2-P, also discloses an experimental process for manufacturing 1,4-bis(4-phenoxybenzoyl)benzene via a nucleophilic route. In said publication, the process was performed by mixing 0.10 mol of a compound of formula (I):

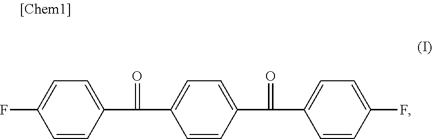 [SMILES: O=C(c1ccc(F)cc1)c1ccc(C(=O)c2ccc(F)cc2)cc1]

0.20 mol of phenol and 0.3 mol of anhydrous potassium carbonate in 270 mL of dimethylacetamide and 60 mL of toluene, with stirring and under a dinitrogen atmosphere. The mixture is gradually heated for 1 hour until a temperature of 158° C. is reached. The residual water is removed from the reaction mixture. The reaction mixture is kept at a temperature of 158° C. for 1 hour, and then at a temperature of 162° C. for 2 hours. The reaction medium is then poured into pure water and the precipitate is filtered off and air-dried for 24 hours at 108° C. Two recrystallizations from toluene are performed and a product with a melting point of 224° C. is obtained in a yield of 90%, although no purity is indicated. However, the literature indicates that the melting point of 1,4-bis(4-phenoxybenzoyl)benzene should be 215° C. This process also has several drawbacks: it uses large amounts of solvents, notably of dimethylacetamide, which presents a risk to human health as it is harmful (by contact/inhalation) and CMR (may harm the fetus). Furthermore, dimethylacetamide has a high boiling point (165° C.), which complicates the step of drying the resulting product. Finally, the water produced in the course of the reaction is soluble in dimethylacetamide but is difficult to separate therefrom, which complicates the recycling of the solvent for reuse in subsequent processes.

### OBJECTS

One object of the invention is to propose an improved process for manufacturing aromatic diether(s), which may notably be deployed on an industrial scale.

According to certain embodiments, the object of the invention is to propose a process for manufacturing high-purity aromatic diether(s) in high yield. An object of the invention is also to propose an improved process for manufacturing polyaryl ether ketone from said aromatic diethers.

### PRESENTATION OF THE INVENTION

The invention relates to a process for manufacturing an aromatic diether, comprising the reaction of a compound A comprising at least two halogenated aromatic groups with a compound B, B being an aromatic alkoxide, optionally in the presence of a compound C acting as reaction solvent. The molar proportion of compound B to compound A is at least 2:1 and the molar amount of compound C to compound A is, where appropriate, not more than 10:1.

This process makes it possible to obtain aromatic diethers in a highly concentrated reaction mixture, even in bulk, which makes it possible to optimize the volume productivity (amount of material produced per unit volume of equipment). In addition, the inventors have noted, entirely surprisingly, that the process allows the aromatic diether to be obtained in a yield at least equivalent to, and in many cases better than, that of processes according to the prior art and with good purity.

In certain embodiments, compound A is a compound having the chemical formula:

[Chem 2]

X₁—Ar—[Zᵢ—Arᵢ]ₙ—X₂ (II),

in which:
i is an integer ranging from 1 to 3, and n is an integer equal to 0 or 1;
X₁ and X₂ independently denote a halogen atom;
Ar and, for any i, Arᵢ independently denote a substituted or unsubstituted divalent aromatic group; and
for any i, Zᵢ independently denotes an oxygen atom, a sulfur atom, an alkylene group, such as —CH₂— or isopropylene (—C(CH₃)₂—), a carbonyl group or a sulfonyl group.

Preferentially, X₁ and X₂ denote the same halogen atom. Even more preferentially, they both denote a chlorine or a fluorine.

Preferentially, Ar and, for any i, Arᵢ independently denote a divalent aromatic group chosen from the list consisting of: 1,3-phenylene, 1,4-phenylene, 1,1′-biphenyl divalent in the 4,4′ positions, 1,1′-biphenyl divalent in the 3,4′ positions, 1,4-naphthylene, 1,5-naphthylene and 2,6-naphthylene, and even more preferentially independently denote 1,3-phenylene and 1,4-phenylene.

Preferentially, for any i, Zᵢ independently denotes an oxygen atom or a carbonyl group, and even more preferentially denotes a carbonyl group.

According to certain embodiments, in formula (II) of compound A:
i is equal to 2 and n is equal to 1;
X₁ and X₂ both denote a chlorine atom or a fluorine atom;
Ar and Ar₂ both denote a 1,4-phenylene group;
Ar₁ denotes a 1,3-phenylene or 1,4-phenylene group; and
Z₁ and Z₂ both denote a carbonyl group.

In certain embodiments, compound B has the chemical formula:

Ar′—O— (III),

in which:
Ar′ denotes a substituted or unsubstituted monovalent aromatic group, preferentially denotes a monovalent aromatic group chosen from the list consisting of: phenyl, biphenyl and naphthylene. Compound B may notably be phenoxide.

In certain embodiments, the molar proportion of compound B to compound A is less than or equal to 3:1, preferentially less than or equal to 2.5:1, more preferentially less than or equal to 2.3:1, and extremely preferably about 2:1.

According to certain embodiments, compound B is obtained by deprotonation of the aromatic alcohol B″, the conjugate acid of the aromatic alkoxide B, with a base reacted with B″, in situ or ex situ, to give compound B, said base being preferentially chosen from the list consisting of: salts of aromatic or aliphatic alkoxides, carbonate salts, metal hydrides and alkali metals.

The base reacted with B″ may notably be a linear or branched alkoxide salt comprising from 3 to 10 carbon atoms. Preferentially, said base is chosen from the list consisting of salts of:

isopropoxide, 1,2-dimethylpropoxide, 1,1-dimethylpropoxide, 2,2-dimethylpropoxide, 1,1,2-trimethylpropoxide, 1,2,2-trimethylpropoxide, 1-ethyl-2-methylpropoxide, 1-ethylpropoxide, n-butoxide, isobutoxide, sec-butoxide, tert-butoxide, 2-methylbutoxide, 3-methylbutoxide, 1,2-dimethylbutoxide, 1,3-dimethylbutoxide, 2,3-dimethylbutoxide, 1,1-dimethylbutoxide, 2,2-dimethylbutoxide, 3,3-dimethylbutoxide, 1-ethylbutoxide, 2-ethylbutoxide, 1-propylbutoxide, 1,1,3,3-tetramethylbutoxide, n-pentoxide, 2-pentoxide, 2-methylpentoxide, n-hexoxide, 2-hexoxide, 3-methylpentoxide, 4-methylpentoxide, 2-ethylpentoxide, 2-ethylhexoxide, 2-propylheptoxide, n-heptoxide, 2-heptoxide, 3-heptoxide, n-octoxide, and mixtures thereof;

even more preferentially, said base may be chosen from the list of salts of isopropoxide, n-butoxide, tert-butoxide, n-heptoxide, n-octoxide, and a mixture thereof.

The base reacted with B″ may also be a carbonate salt.

The base reacted with B″ may notably be an alkali metal salt. Preferentially, the base is a sodium or potassium salt or a mixture of sodium and potassium salts.

The base reacted with B″ may also be sodium metal or potassium metal, preferentially sodium metal.

According to certain embodiments, the molar proportion of the base reacted with B″ relative to B″ is less than or equal to 1:1.

According to certain embodiments, compound C has a polarity measured at 20° C. of greater than or equal to 3 Debyes, preferentially greater than or equal to 3.5 Debyes.

According to certain embodiments, compound C is chosen from the list consisting of: C1-C6-alkyl-2-pyrrolidones, notably N-methyl-2-pyrrolidone or N-butyl-2-pyrrolidone,

sulfoxides, notably dimethyl sulfoxide or diethyl sulfoxide,

sulfones, notably dimethyl sulfone, diethyl sulfone, diisopropyl sulfone, diphenyl sulfone or tetramethylene sulfone,

nitriles, notably acetonitrile, propionitrile or benzonitrile,

N-dimethylamides, notably dimethylacetamide or dimethylformamide,

and a mixture thereof.

According to particular embodiments, compound C may be diphenyl sulfone.

According to certain embodiments, the molar proportion of compound C relative to compound A is less than or equal to 7.5:1, preferentially less than or equal to 5:1, more preferentially less than or equal to 3:1.

According to certain embodiments, compound A is reacted with compound B, in the absence of any solvent.

According to certain embodiments, compound A is reacted in molten form with compound B.

The process according to the invention also relates to a process for manufacturing a polyaryl ether ketone polymer, comprising: manufacturing an aromatic diether as described above and reacting said aromatic diether with a compound D comprising at least two acyl chloride groups.

According to certain embodiments, compound D is a compound having the chemical formula:

[Chem 3]

ClC(O)—Ar—[Zⱼ—Arⱼ]ₘ—C(O)Cl (IV),

in which:
j is an integer ranging from 1 to 3 and m is an integer equal to 0 or 1;
Ar and, for any j, Arⱼ independently denote a substituted or unsubstituted divalent aromatic group, and preferentially denote a divalent aromatic group chosen from the list consisting of: 1,3-phenylene, 1,4-phenylene, 1,1′-biphenyl divalent in the 4,4′ positions, 1,1′-biphenyl divalent in the 3,4′ positions, 1,4-naphthylene, 1,5-naphthylene and 2,6-naphthylene; and,
for any j, Zⱼ independently denotes an oxygen atom, a sulfur atom, an alkylene group, such as —CH₂— or isopropylene (—C(CH₃)₂—), or a sulfone; preferentially, Zⱼ denotes an oxygen atom.

According to certain embodiments, said aromatic diether is chosen from the list consisting of:

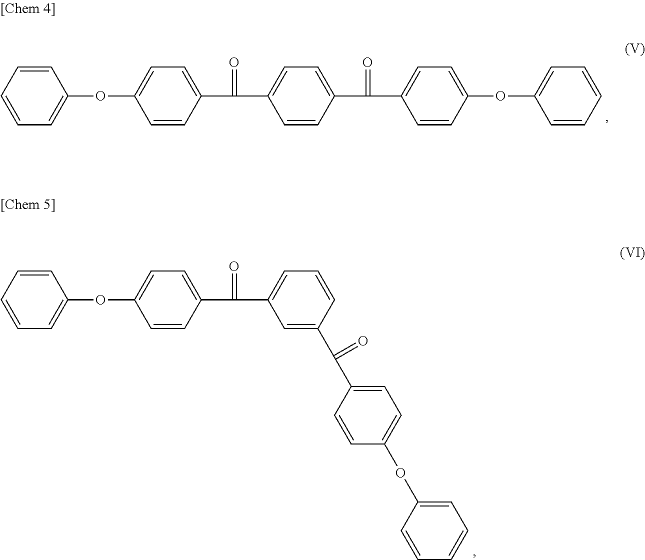 [SMILES: O=C(c1ccc(Oc2ccccc2)cc1)c1ccc(C(=O)c2ccc(Oc3ccccc3)cc2)cc1 ; O=C(c1ccc(Oc2ccccc2)cc1)c1cccc(C(=O)c2ccc(Oc3ccccc3)cc2)c1]

or a mixture thereof; and

compound D is chosen from the list of compounds consisting of:

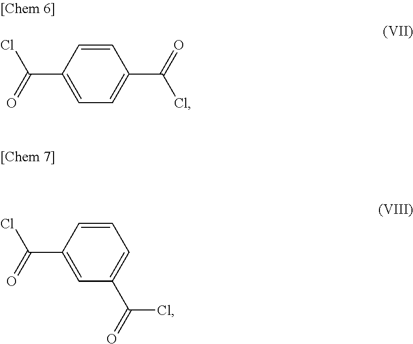 [SMILES: O=C(Cl)c1ccc(C(=O)Cl)cc1 ; O=C(Cl)c1cccc(C(=O)Cl)c1]

or a mixture thereof.

### DETAILED DESCRIPTION OF THE INVENTION

Compound A comprises at least two halogenated aromatic groups.

An aromatic group is a group comprising a conjugated ring with significantly greater stability (due to delocalization) than that of a hypothetical localized structure. Advantageously, the aromatic groups of compound A are aromatic hydrocarbons.

Each halogenated aromatic group bears at least one halogen atom substituting for a hydrogen atom. Advantageously, each halogenated aromatic group bears a single halogen atom substituting for a hydrogen atom.

The aromatic groups may also independently comprise other substituent(s) for one or more remaining hydrogen atom(s), this/these other substituent(s) being chosen from: alkyl, alkenyl, alkynyl, aryl, ether, thioether, carboxylic acid, ester, amide, imide, alkali or alkaline-earth metal sulfonate, alkyl sulfonate, alkali or alkaline-earth metal phosphonate, amine and quaternary ammonium.

According to certain embodiments, the aromatic groups may also independently comprise a single other substituent for a hydrogen atom, this substituent preferentially being: an aryl or an alkali metal sulfonate.

According to certain embodiments, compound A may bear two halogenated aromatic groups only.

According to certain embodiments, compound A may be a compound having the chemical formula:

[Chem 8]

X₁—Ar—[Zᵢ—Arᵢ]ₙ—X₂ (II).

In this formula:
i is an integer ranging from 1 to 3, and n is an integer equal to 0 or 1;
X₁ and X₂ independently denote a halogen atom;
Ar and, for any i, Arᵢ independently denote a substituted or unsubstituted divalent aromatic group; and
for any i, Zᵢ independently denotes an oxygen atom, a sulfur atom, an alkylene group, such as —CH₂— or isopropylene (—C(CH₃)₂—), a carbonyl group or a sulfonyl group.

Preferentially, in the compound of formula (II):
X₁ and X₂ may denote the same halogen atom; X₁ and X₂ may notably both denote a chlorine or a fluorine;
Ar and, for any i, Arᵢ may independently denote a divalent aromatic group chosen from the list consisting of: 1,3-phenylene, 1,4-phenylene, 1,1′-biphenyl divalent in the 4,4′ positions, 1,1′-biphenyl divalent in the 3,4′ positions, 1,4-naphthylene, 1,5-naphthylene and 2,6-naphthylene; Ar and, for any i, Arᵢ may notably independently denote 1,3-phenylene and 1,4-phenylene;
for any i, Zᵢ may independently denote an oxygen atom or a carbonyl group; for any i, Zᵢ may notably denote a carbonyl group.

According to particular embodiments, compound A may be compound A₁, A₂, A₃ or A₄ as defined in the examples, or a mixture of these compounds.

Compound B is an aromatic alkoxide. Compound B includes an aromatic group which is advantageously a hydrocarbon.

The aromatic ring comprises at least one alkoxide function substituting for a hydrogen atom. The aromatic ring may notably bear a single alkoxide function.

Alternatively, the aromatic ring may bear two alkoxide functions.

The aromatic ring of B may also comprise other substituent(s) for one or more remaining hydrogen atom(s), this/these other substituent(s) being chosen from: alkyl, alkenyl, alkynyl, aryl, ether, thioether, carboxylic acid, ester, amide, imide, alkali or alkaline-earth metal sulfonate, alkylsulfonate, alkali or alkaline-earth metal phosphonate, amine and quaternary ammonium. In particular, the aromatic ring of B may comprise a single other substituent for a hydrogen atom, this substituent preferentially being: an aryl or an alkali metal sulfonate.

According to certain embodiments, compound B is a compound having the chemical formula:

Ar′—O— (III).

In this formula, Ar′ denotes a substituted or unsubstituted monovalent aromatic group. Preferentially, Ar′ denotes a monovalent aromatic group chosen from the list consisting of: phenyl, monovalent biphenyl and naphthyl.

According to particular embodiments, compound B is phenoxide.

The molar proportion of compound B to compound A is at least 2:1. This is because the reaction of B with A desirably results in a double substitution reaction of two molecules of B with one molecule of A to form an aromatic diether.

According to certain embodiments, the molar proportion of compound B to compound A is less than or equal to 3:1, preferentially less than or equal to 2.5:1, more preferentially less than or equal to 2.3:1, and extremely preferably about 2:1.

The reaction medium is referred to as the “reaction mixture” once the two reagents, i.e. compound A and compound B, have been placed in contact.

The “reaction time” corresponds to the time the reagents are reacted with each other.

Once the reaction is completed to the desired conversion, preferentially to total conversion of compound A into products, the reaction mixture is then referred to as the “product mixture”.

The “reaction temperature” corresponds to the temperature of the reaction mixture during the reaction time.

The “reaction pressure” corresponds to the pressure exerted on the reaction mixture during the reaction time.

The reaction may be performed in a reactor. The reactor may be, for example, a glass reactor, a reactor with a glass inner wall or a reactor made of stainless metal materials, or lined with PTFE.

Preferentially, the reaction may be performed in a reaction mixture that substantially does not comprise any water.

Preferentially, the reaction may be performed in an atmosphere that substantially does not comprise any water or dioxygen, for example under a nitrogen or argon atmosphere.

Preferentially, the reaction mixture may be stirred for all or part of the reaction time. Thus, the reactor is preferably provided with a stirring device such as a mechanical stirrer (which may comprise, for example, one or more blades) or a recirculation loop with a pump.

According to certain embodiments, the reaction may be performed in the presence of a compound C acting as a solvent. Reagents and/or reaction intermediates and/or reaction products may dissolve therein, at least partially. In these embodiments, the molar amount of compound C relative to compound A is not more than 10:1, i.e. the reaction is performed as a concentrated reaction mixture. This notably has the effect of minimizing the introduction of solvent-mediated impurities into the reaction mixture.

The solvent may be chosen from the list consisting of: linear or branched alcohols, comprising from 3 to 10 carbon atoms, C1-C6-alkyl-2-pyrrolidones, sulfoxides, sulfones, nitriles, N-dimethylamides and a mixture thereof.

The solvent may notably be a linear or branched alcohol comprising from 3 to 10 carbon atoms. The alcohol is preferentially nonaromatic. As explained hereinbelow, the solvent alcohol may notably be generated during a step of deprotonation of the aromatic alcohol, the conjugate of the aromatic alkoxide B, with an alkoxide salt. The solvent alcohol may be chosen from the list consisting of: isopropanol, 1,2-dimethylpropanol, 1,1-dimethylpropanol, 2,2-dimethylpropanol, 1,1,2-trimethylpropanol, 1,2,2-trimethylpropanol, 1-ethyl-2-methyl propoxide, 1-ethyl propoxide, n-butanol, isobutanol, sec-butanol, tert-butanol, 2-methylbutanol, 3-methylbutanol, 1,2-dimethylbutanol, 1,3-dimethylbutanol, 2,3-dimethylbutanol, 1,1-dimethylbutanol, 2,2-dimethylbutanol, 3,3-dimethylbutanol, 1-ethylbutanol, 2-ethylbutanol, 1-propylbutanol, 1,1,3,3-tetramethylbutanol, n-pentanol, 2-pentanol, 2-methylpentanol, n-hexanol, 2-hexanol, 3-methylpentanol, 4-methylpentanol, 2-ethylpentanol, 2-ethylhexanol, 2-propylheptanol, n-heptanol, 2-heptanol, 3-heptanol, n-octanol, and a mixture thereof.

Preferentially, the solvent alcohol may be chosen from the list consisting of: isopropanol, n-butanol, tert-butanol, n-heptanol, n-octanol, and a mixture thereof.

The solvent may also be a C1-C6-alkyl-2-pyrrolidone, the alkyl group comprising from 1 to 6 carbons. Advantageously, the C1-C6-alkyl-2-pyrrolidone may be N-methyl-2-pyrrolidone or N-butyl-2-pyrrolidone.

The solvent may also be a sulfone. Advantageously, the sulfone may be dimethyl sulfone, diethyl sulfone, diisopropyl sulfone, diphenyl sulfone or tetramethylene sulfone. According to particularly advantageous embodiments, the solvent may be diphenyl sulfone.

The solvent may also be a nitrile. Advantageously, the nitrile may be acetonitrile, propionitrile or benzonitrile.

The solvent may also be an N-dimethylamide. Advantageously, the N-dimethylamide is dimethylacetamide or dimethylformamide.

According to certain embodiments, the solvent has a polarity measured at 20° C. of greater than or equal to 3 Debyes, preferentially greater than or equal to 3.5 Debyes. This level of polarity enables better dissolution of the reagents and reaction intermediates, thus facilitating the nucleophilic substitution reaction.

The molar proportion of compound C relative to compound A is less than or equal to 10:1. Thus, the process allows the production of aromatic diethers in a highly concentrated reaction mixture, or even in bulk, thus allowing the volume production to be optimized. In addition, the aromatic diether may be obtained in an at least equivalent, and in many cases better, yield than that in the prior art processes and with good purity.

The molar proportion of compound C relative to compound A may preferentially be less than or equal to 7.5:1, more preferably less than or equal to 5:1 and extremely preferably less than or equal to 3:1.

In certain embodiments, compound C may be an “ACS grade” solvent, i.e. a solvent having the purity limits defined by the American Chemical Society (A.C.S) purity limits. Compound C may have a purity of greater than or equal to 95%, or greater than or equal to 96%, or greater than or equal to 97%, or greater than or equal to 98%, or greater than or equal to 99%. Compound C may notably not be a high-purity solvent of the grades used in analytical chemistry.

In certain embodiments, certain purity parameters for compound C may nevertheless be controlled. Compound C should notably not exceed certain amounts, typically less than 100 ppm, preferentially less than 50 ppm, of halide ions (Cl⁻, F⁻), of alkali metal ions (Na⁺, K⁺), of metal ions (Fe(II), Fe(III)) and of water.

According to other embodiments, the reaction may be performed in the absence of any solvent. The reaction of the reaction mixture is then referred to as a “bulk” reaction. This embodiment has the additional advantage of dispensing with any step of recycling the reaction solvent, which would in principle be necessary if the process were to be scaled up to an industrial scale. It also has the advantage of limiting the pressure increase inside the reactor.

According to certain embodiments, the reaction temperature is such that compound A and compound B are in molten form and/or dissolved in the reaction mixture for all or part of the reaction time. Advantageously, compound A is in molten form (above the melting point) and compound B is dissolved in the molten compound A and/or, where appropriate, in compound C acting as solvent, for at least 50%, or at least 60%, or at least 70%, or at least 80%, or at least 90% of the reaction time.

According to certain embodiments, the reaction temperature is such that the aromatic diether, the desired product of the reaction of compound A with compound B, is in molten form and/or dissolved in the molten compound A for all or part of the reaction time. Notably, the aromatic diether may be in molten form and/or dissolved in the molten compound A for at least 10%, or at least 20%, or at least 30%, or at least 40%, or at least 50%, or at least 60%, or at least 70%, or at least 80%, or at least 90% or at least 95% of the reaction time.

According to certain particular embodiments, notably in embodiments in which compound A may be compound A₁, A₂, A₃ or A₄, as defined in the examples, the reaction mixture is heated to a temperature of at least 165° C., preferentially at least 170° C. or at least 180° C. or at least 190° C. for at least 50%, or at least 60%, or at least 70%, or at least 80%, or at least 90% or at least 95% of the reaction time.

According to certain embodiments, the reaction time is between 5 minutes and 5 days, preferentially between 10 minutes and 24 hours, more preferentially between 30 minutes and 5 hours.

According to certain embodiments, compound A is added to compound B or the mixture of B and C.

According to certain embodiments, the reaction of compound A with compound B is performed at atmospheric pressure or close to atmospheric pressure. Compound B may be obtained by deprotonation of the aromatic alcohol B″, the conjugate acid of the aromatic alkoxide B. B″ then has the chemical formula:

Ar′—OH (IIIa).

According to a particular embodiment, B″ is phenol.

Compound B″ may be deprotonated with a base suitable for the deprotonation of aromatic alcohols.

The base may be chosen from the list consisting of aromatic or aliphatic alkoxide salts, carbonate salts, metal hydrides, and alkali metals.

The base may notably be chosen from the salts of linear or branched alkoxides, comprising from 3 to 10 carbon atoms. In this embodiment, the base, by reacting with a proton, becomes an alcohol which can, if kept in the reaction mixture, act as a solvent. The base may preferentially be chosen from the list consisting of salts of: isopropoxide, 1,2-dimethylpropoxide, 1,1-dimethylpropoxide, 2,2-dimethylpropoxide, 1,1,2-trimethylpropoxide, 1,2,2-trimethylpropoxide, 1-ethyl-2-methylpropoxide, 1-ethylpropoxide, n-butoxide, isobutoxide, sec-butoxide, tert-butoxide, 2-methylbutoxide, 3-methylbutoxide, 1,2-dimethylbutoxide, 1,3-dimethylbutoxide, 2,3-dimethylbutoxide, 1,1-dimethylbutoxide, 2,2-dimethylbutoxide, 3,3-dimethylbutoxide, 1-ethylbutoxide, 2-ethylbutoxide, 1-propylbutoxide, 1,1,3,3-tetramethylbutoxide, n-pentoxide, 2-pentoxide, 2-methylpentoxide, n-hexoxide, 2-hexoxide, 3-methylpentoxide, 4-methylpentoxide, 2-ethylpentoxide, 2-ethylhexoxide, 2-propylheptoxide, n-heptoxide, 2-heptoxide, 3-heptoxide, n-octoxide, and mixtures thereof;

more preferentially, said base is chosen from the list of salts of isopropoxide, n-butoxide, tert-butoxide, n-heptoxide, n-octoxide, and mixtures thereof.

The base may also be a carbonate salt. The carbonate salt may notably be in the form of a powder, the powder having a particle size distribution such that D90 has a value ranging from 45 micrometers to 250 micrometers and D99.5 has a value of less than or equal to 710 micrometers, the particle size distribution being measured by laser diffraction, according to the standard ISO 13320: 2009.

In certain embodiments, where the base is a salt, the salt may notably be an alkali metal salt. Preferentially, the salt may be a sodium salt, a potassium salt or a mixture of sodium and potassium salts.

The base may also be sodium metal, lithium metal or potassium metal, preferentially sodium metal.

The base may also be sodium hydride, lithium hydride or potassium hydride.

The deprotonation step of B″ may be performed in-situ or ex-situ relative to the reaction of compound A with compound B.

According to certain embodiments, the molar proportion of said base relative to B″ is less than or equal to 1:1. This advantageously ensures a quantitative reaction of said base.

According to a first variant, the process successively comprises: a first step of deprotonation of B″ with a base to form compound B, and a second step of reacting compound B with compound A, optionally in the presence of a compound C acting as reaction solvent.

Between the first and second steps, a step of removing the excess B″, and/or any solvent(s) used or generated during the first step, and/or water, may advantageously be performed, if necessary.

According to a second variant, the base, compound B″, compound A, and, where appropriate, compound C, may be mixed with each other in any order to form the reaction mixture.

Once the reaction is completed to the desired conversion, the reaction mixture is referred to as the “product mixture”. The product mixture may be purified and the aromatic diether isolated as described below.

The reaction product residue, obtained from the reaction of compound A with compound B, may be purified by means of methods that are well known to those skilled in the art, including one or more distillation steps, one or more solid/liquid separation steps, one or more washing steps, one or more extraction steps and one or more recrystallization steps.

In the embodiments in which the reaction of compound A with compound B was performed with compound C acting as the reaction solvent, said solvent may be removed so as to obtain a solvent-free residue of the reaction products.

When the aromatic diether is sufficiently insoluble in the reaction solvent, it may be recovered via any solid/liquid separation means. The solid/liquid separation may be performed in one or more successive steps, each step being chosen from the group consisting of: centrifugal filtration, sedimentation, centrifugal decantation, vacuum filtration, pressure filtration and gravity filtration. The solid/liquid separation temperature must be sufficiently low to decrease the solubility of the aromatic diether in the reaction solvent.

Alternatively and advantageously, the reaction solvent may be removed by distillation or also by displacement with another solvent having a lower boiling point.

Preferentially, the solvent-free residue of the reaction products, whether A was reacted with B in the presence or absence of compound C, may be purified via one or more washing steps or purified by sublimation or crystallization.

Methods for purifying the reaction product residues comprising 1,4-bis(4-phenoxybenzoyl)benzene and/or 1,3-bis(4-phenoxybenzoyl)benzene are explained below. However, a person skilled in the art would know how to adapt these methods, notably how to choose the solvents to use, for other aromatic diethers manufactured according to the invention.

A step of washing the residue comprising 1,4-bis(4-phenoxybenzoyl)benzene and the residue comprising 1,3-bis(4-phenoxybenzoyl)benzene may comprise the addition of a washing solvent (and the selection of a corresponding temperature) in which 1,4-bis(4-phenoxybenzoyl)benzene and/or 1,3-bis(4-phenoxybenzoyl)benzene are sparingly soluble, but in which impurities, such as salts and/or unreacted reagents (notably phenoxide), are soluble.

Advantageously, the residue is placed in contact with a protic washing solvent, such as water or a water/methanol mixture (95/5) at room temperature (25° C.) for a sufficient contact time.

In certain embodiments, the residue may be ground into fine particles, if necessary so as to improve the washing solvent/residue contact surface area.

In certain embodiments, the residue is suspended in the washing solvent with stirring, so as to keep the residue in contact with the washing solvent for a sufficient amount of time.

The residue/washing solvent mixture is then separated by a solid/liquid separation means, for example by filtration or by centrifugation. The solid phase may advantageously be dried so as to remove any trace of solvent.

The 1,3-bis(4-phenoxybenzoyl)benzene and/or the 1,4-bis(4-phenoxybenzoyl)benzene may advantageously be dissolved in an extraction solvent, such as chloroform or acetone, at room temperature. After solid/liquid separation, a liquid phase essentially containing 1,3-bis(4-phenoxybenzoyl)benzene and/or 1,4-bis(4-phenoxybenzoyl)benzene may be recovered, the purified product finally being able to be obtained by removal of the extraction solvent (distillation). Advantageously, the 1,4-bis(4-phenoxybenzoyl)benzene may be extracted with chloroform. Advantageously, the 1,3-bis(4-phenoxybenzoyl)benzene may be extracted with acetone.

In certain embodiments, the residue may be purified by means of a final recrystallization step. In these embodiments, the residue preferentially undergoes only one recrystallization step. This is generally made possible due to the relatively low level of impurities to be removed, partly due to the fact that the reaction mixture was produced in a highly concentrated medium, or even in bulk.

The 1,4-bis(4-phenoxybenzoyl)benzene may also advantageously be recrystallized from toluene.

The 1,3-bis(4-phenoxybenzoyl)benzene may also advantageously be recrystallized from methanol.

The purity of the aromatic diether may be determined by a number of common characterization methods, notably by nuclear magnetic resonance (NMR), differential scanning calorimetry (DSC), high performance liquid chromatography (HPLC) and/or ultra high performance liquid chromatography (UPLC).

Preferably, the aromatic diether is obtained in a purity of greater than or equal to 95%, preferably greater than or equal to 99% and more preferably greater than or equal to 99.9%, evaluated by NMR (molar percentage).

Alternatively, the aromatic diether is obtained in a purity of greater than or equal to 95%, preferably greater than or equal to 99% and more preferably greater than or equal to 99.9%, evaluated by HPLC (mass percentage).

The aromatic diether obtained according to the embodiments of the invention may then be used to perform an electrophilic polymerization reaction so as to manufacture a polyaryl ether ketone (PAEK) polymer, the aromatic diether being reacted with a compound D comprising at least two acyl chloride groups. Compound D may be a compound having the chemical formula:

[Chem 9]

ClC(O)—AR—[Zⱼ—Arⱼ]ₘ—C(O)Cl (IV),

in which:
j is an integer ranging from 1 to 3 and m is an integer equal to 0 or 1;
Ar and, for any j, Arⱼ independently denote a substituted or unsubstituted divalent aromatic group; and
for any j, Zⱼ independently denotes an oxygen atom, a sulfur atom, an alkylene group, such as —CH₂— or isopropylene (—C(CH₃)₂—), or a sulfone.

Preferentially, Ar and, for any j, Arⱼ denote a divalent aromatic group chosen from the list consisting of:

1,3-phenylene, 1,4-phenylene, 1,1′-biphenyl divalent in the 4,4′ positions, 1,1′-biphenyl divalent in the 3,4′ positions, 1,4-naphthylene, 1,5-naphthylene and 2,6-naphthylene.

Preferentially, for any j, Zⱼ denotes an oxygen atom.

According to certain embodiments, compound D may be chosen from the list consisting of: phthaloyl dichloride, isophthaloyl dichloride, terephthaloyl dichloride, or a mixture thereof. Preferentially, compound D may be chosen from the list consisting of: isophthaloyl dichloride, terephthaloyl dichloride or a mixture thereof.

According to certain particular embodiments, the aromatic diether synthesized according to the invention may be chosen from the list consisting of: 1,4-bis(4-phenoxybenzoyl)benzene, 1,3-bis(4-phenoxybenzoyl)benzene, or a mixture thereof.

Thus, in the embodiment in which the PAEK is a polyether ketone ketone, the difunctional aromatic acyl chloride may be phthaloyl dichloride, terephthaloyl dichloride, isophthaloyl dichloride, or a mixture thereof and the aromatic diether: 1,4-bis(4-phenoxybenzoyl)benzene, 1,3-bis(4-phenoxybenzoyl)benzene, or a mixture thereof.

The polymerization reaction is preferably performed in a solvent. The solvent is preferably an aprotic solvent, which may notably be chosen from the list consisting of: methylene chloride, carbon disulfide, ortho-dichlorobenzene, meta-dichlorobenzene, para-dichlorobenzene, 1,2,4-trichlorobenzene, 1,2,3-trichlorobenzene, ortho-difluorobenzene, 1,2-dichloroethane, 1,1-dichloroethane, 1,1,2,2-tetrachloroethane, tetrachloroethylene, dichloromethane, nitrobenzene, or a mixture thereof. ortho-Dichlorobenzene is particularly preferred for manufacturing the polyether ketone ketones.

The polymerization reaction is preferably performed in the presence of a Lewis acid as catalyst.

The Lewis acid may notably be chosen from the list consisting of: aluminum trichloride, aluminum tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride. Aluminum trichloride, boron trichloride, aluminum tribromide, titanium tetrachloride, antimony pentachloride, ferric chloride, gallium trichloride and molybdenum pentachloride are preferred. Aluminum trichloride is particularly preferred for manufacturing the polyether ketone ketones.

According to certain variants, the polymerization may be performed in the same reactor as that used for the production of the aromatic diether. Preferentially, however, the polymerization is performed in another reactor.

The polymerization may be performed at a temperature ranging, for example, from 20 to 120° C.

The process for manufacturing PAEK, and notably polyether ketone ketones, advantageously comprises one or more steps of purifying the polymer, such as the steps of:
mixing the PAEK-containing polymerization reaction products with a protic solvent so as to provide a PAEK suspension;
separating the PAEK polymer from the PAEK suspension, preferably by filtration and washing.

The protic solvent used for the PAEK suspension may be, for example, methanol.

The PAEK polymer may then be recovered from the PAEK suspension by filtration. If necessary, the polymer may be washed, preferably with a protic solvent such as methanol, and filtered again, one or more times. The washing may be performed, for example, by resuspending the polymer in the solvent.

### EXAMPLES

The examples that follow illustrate the invention without, however, limiting it.

### Apparatus Used for the Characterizations

For High Performance Liquid Chromatography (HPLC) measurements, a Waters XterraMS C18 3.5 μm 4.6×150 mm column was used with a mobile phase comprising a mixture: water/acetonitrile+0.05% trifluoroacetic acid, as a gradient. The measurements were taken at 20° C., at variable wavelengths.

For Mass Spectroscopy (MS) measurements, a Waters Xevo G2-XS QTof machine was used with the following parameters:

Introduction of the sample by the ASAP probe (Atmospheric-pressure Solids Analysis Probe)

Ionization mode: Positive ASAP

Mass range: 50-1000 m/z

Source temperature: 120° C.

Corona current: 10 μA

Cone voltage: 50 V

For proton Nuclear Magnetic Resonance (¹H NMR) measurements, Brüker Avance III (500 MHz) and Bruker Neo (600 MHz) spectrometers were used with CDCl₃ as solvent.

For carbon Nuclear Magnetic Resonance (¹³C NMR) measurements, Brüker Avance III 500 MHz (125 MHz) and Brüker Neo 600 MHz (150 MHz) spectrometers were used with CDCl₃ as solvent.

For the melting point measurements, a Kofler bench and a Gallenkamp melting point apparatus (with capillary tubes) were used.

The crude yield is defined hereinbelow as the ratio of the number of moles of product obtained at the end of the reaction to the number of moles of dihalo compound introduced.

Hereinbelow, the term “purified product yield” means the ratio of the number of moles of purified product (expected product), i.e. of the crude product which has notably been washed and/or extracted and/or recrystallized, to the number of moles of dihalo compound introduced. This yield is associated with a purity evaluated by NMR (molar %) or by HPLC (mass %).

### Example 1

### 1,4-Bis(4-fluorobenzoyl)benzene

Compound A₁ of formula:

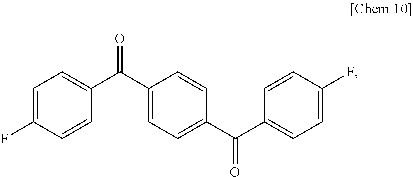 [SMILES: O=C(c1ccc(F)cc1)c1ccc(C(=O)c2ccc(F)cc2)cc1]

was synthesized under the following conditions: 1 equivalent (eq.) of terephthaloyl chloride (5 g; 24.6 mmol), 10 equivalents of fluorobenzene (28 g), 2.1 equivalents of AlCl₃ (6.9 g; 51.7 mmol). The fluorobenzene used in this reaction served both as reagent and as solvent. Aluminum chloride was added at 25° C. portionwise (over 10 min) to terephthaloyl chloride dissolved in fluorobenzene, with stirring and under an argon atmosphere. At the end of the addition of AlCl₃, the reaction mixture was kept stirring for 2 hours at 60° C. After cooling, the product mixture obtained was then poured onto ice-water followed by evaporation of the excess fluorobenzene under vacuum on a rotary evaporator. The white solid obtained was filtered off, washed several times with distilled water, with 10% aqueous sodium hydroxide, then with water and finally dried under vacuum. The expected product A₁ was obtained in a yield of about 99.1%. Crystallization of the crude product from dimethylacetamide gave the purified product in a yield of about 96% and a purity >99.5% (NMR and MS). The product obtained in the form of white crystals is soluble in chloroform, acetone, dichloromethane and partially in methanol. Its measured melting point was 220° C.

### Example 2

### 1,3-Bis(4-fluorobenzoyl)benzene

Compound A₂ of formula:

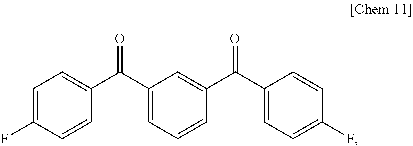 [SMILES: O=C(c1ccc(F)cc1)c1cccc(C(=O)c2ccc(F)cc2)c1]

was synthesized in substantially the same manner as compound A₁ of Example 1, except that isophthaloyl dichloride was used instead of terephthaloyl dichloride.

After treatment similar to that applied for compound A₁, compound A₂ was obtained in almost quantitative yield in the form of white crystals with a measured melting point of 181° C.

The product is soluble in common solvents. It was crystallized from toluene. The yield obtained was about 95%. The purity according to NMR, MS and HPLC was about 99.8%.

### Example 3

### 1,4-Bis(4-chlorobenzoyl)benzene

Compound A₃ of formula:

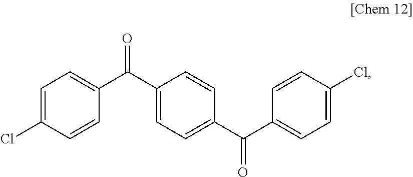 [SMILES: O=C(c1ccc(Cl)cc1)c1ccc(C(=O)c2ccc(Cl)cc2)cc1]

was synthesized in substantially the same manner as compound A₁ of Example 1, except that chlorobenzene was used instead of fluorobenzene.

Nevertheless, certain reaction conditions were modified, affording a better yield of the expected product. The reaction conditions were as follows: 1 equivalent of terephthaloyl chloride (5 g; 24.6 mmol), 16 eq. of chlorobenzene (44.35 g (40 ml), 0.394 mol) and 2.4 eq. of AlCl₃ (7.88 g, 59.1 mmol). Aluminum chloride was added to terephthaloyl chloride dissolved in chlorobenzene, portionwise (over 10 minutes) with stirring under an argon atmosphere at RT. The chlorobenzene used in this reaction serves both as reagent and as solvent. At the end of addition of AlCl₃, the reaction mixture was stirred overnight at 25° C. and then for 3 hours at 90° C. After a treatment identical to that for compound A₁, the expected product A₃ was obtained in almost quantitative yield in the form of a white powder. Crystallization of the crude product from dimethylacetamide (DMAc) gave the pure product in the form of white crystals with a melting point equal to 259° C. The yield of crystallized product was about 96%. A high temperature NMR study showed a selectivity strictly greater than 99.6%.

### Example 4

### 1,3-Bis(4-chlorobenzoyl)benzene

Compound A₄ of formula:

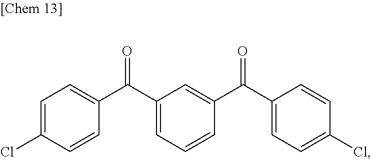 [SMILES: O=C(c1ccc(Cl)cc1)c1cccc(C(=O)c2ccc(Cl)cc2)c1]

was synthesized in substantially the same manner as compound A₁ of Example 1, except that chlorobenzene was used instead of fluorobenzene and isophthaloyl dichloride was used instead of terephthaloyl dichloride.

Nevertheless, certain reaction conditions were modified as detailed below.

On conclusion of the addition of the aluminum chloride portionwise to the isoterephthaloyl chloride dissolved in chlorobenzene at room temperature, the reaction medium was stirred for 10 hours at this temperature and then for 2 hours at 90° C. After cooling and evaporating off the excess chlorobenzene, the solid residue obtained was extracted with dichloromethane (DCM). The organic phase was washed twice with water and three times with 10% aqueous sodium hydroxide, and finally twice with water. It was then dried and evaporated under vacuum. The expected product was obtained in the form of white crystals that were pure by NMR and MS (purity strictly greater than 99.6%) with a measured melting point of 215° C. The yield was about 96%.

### Example 5

### M₁/M₁′ Mixture from A₁ as a Dilute Reaction Mixture (Comparative)

A mixture of phenol (0.718 g; 2 eq.) and potassium carbonate (1.055 g; 2 eq.) was dissolved in a solvent mixture: toluene (10 mL)/NBP (10 mL), and refluxed for 1 hour (bath temperature of 130° C.). After the addition of compound A₁, followed by distillation of the toluene, the reaction mixture was heated at 150° C.-160° C. for 2 hours. After treatment of the obtained residue with a water/methanol (95/5) mixture, filtration, washing with a water/methanol (95/5) mixture and drying, the crude product was obtained in the form of a white powder in a yield of 81%.

The structure of the expected product, the aromatic diether M₁of formula:

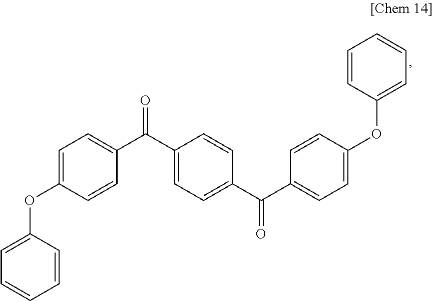 [SMILES: O=C(c1ccc(Oc2ccccc2)cc1)c1ccc(C(=O)c2ccc(Oc3ccccc3)cc2)cc1]

was confirmed by NMR and mass spectroscopy (MS) analyses.

In mass spectroscopy, the presence was detected of the monophenoxy derivative M′₁ (surface area ratio of about 15%) of formula:

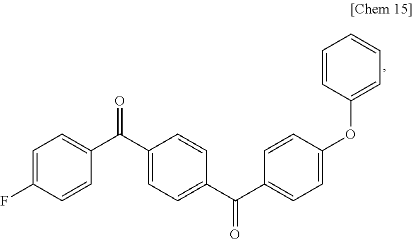 [SMILES: O=C(c1ccc(F)cc1)c1ccc(C(=O)c2ccc(Oc3ccccc3)cc2)cc1]

The yield of product crystallized from toluene was about 72%, with a purity strictly greater than 99%, as measured by NMR.

The measured melting point m.p. was: 208° C.

### Example 6

### M₂/M₂′ Mixture from A₂ as a Dilute Reaction Mixture (Comparative)

In a similar manner to that of Example 5, compound M₂ of formula:

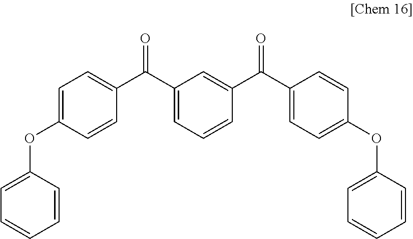 [SMILES: O=C(c1ccc(Oc2ccccc2)cc1)c1cccc(C(=O)c2ccc(Oc3ccccc3)cc2)c1]

was obtained from compound A₂, under conditions similar to those described for the synthesis of M₁, with compound A₂ replacing compound A₁. A difference relative to Example 5 is that the reaction mixture in this case was heated at 150° C.-160° C. for only 30 minutes, after distilling off the toluene.

The product was obtained in the form of a white solid in a crude yield of about 70%.

The structure of the product M₂ was confirmed by NMR and mass spectroscopy analyses.

In mass spectroscopy, the presence was detected of traces of the monophenoxy product M₂′ (about 15%) of formula:

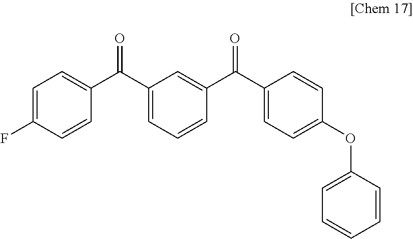 [SMILES: O=C(c1ccc(F)cc1)c1cccc(C(=O)c2ccc(Oc3ccccc3)cc2)c1]

The yield of product crystallized from methanol was about 61%, with a purity strictly greater than 99%, as measured by NMR.

The measured melting point m.p. was: 133° C.

### Example 7

### M₁ from A₁ as a Concentrated Solution (Invention)

In a sealed tube, phenol (2.5 equivalents) and anhydrous potassium bicarbonate (2.5 equivalents), in powder form, and then 0.2 mL of N-butyl-2-pyrrolidone (NBP) were introduced under argon. The reaction mixture was heated at 180° C. with stirring for 30 min. After partial cooling (about 100° C.), 1 mmol (1 equivalent) of compound A₁ was added.

The reaction mixture was then heated at 205° C. for 2 hours. The reaction progress was monitored by HPLC, MS and NMR. It was thus shown that the conversion to the desired product was almost quantitative 2 hours after the end of the addition of compound A₁. Moreover, neither the starting product nor the monophenoxy derivative M₁′ were detected.

The residue obtained was worked up by addition of methanol followed by evaporation under vacuum on a rotary evaporator until the NBP was removed (azeotrope).

The crude product obtained in the form of an off-white solid was extracted with chloroform. After filtering off the insoluble matter and evaporating off the chloroform, the crude product was then crystallized from toluene.

The pure product M₁ (structure confirmed by NMR and MS) was obtained in the form of white crystals in a yield of 83% and with a purity strictly greater than 99 mol %, measured by NMR. The measured melting point was 212° C.

### Example 8

### M₂ from A₂ as a Concentrated Solution (Invention)

In a similar manner to that of Example 7, compound M₂ was obtained from compound A₂ under conditions similar to those described for the synthesis of M₁, with compound A₂ replacing compound A₁. One difference relative to Example 7 is that the crude product obtained in the form of an off-white solid was in this case extracted with acetone instead of chloroform.

The pure product M₂ (structure confirmed by NMR and MS) was obtained in the form of white crystals in a yield of 84%, and a purity strictly greater than 99% in HPLC. The measured melting point was 133° C.

### Example 11

### M₁ from A₁ with a Potassium Alkoxide as Base (Invention)

Phenol (2.3 eq.) and then potassium tert-butoxide (t-BuOK; 2.2 eq.) were introduced into a sealed tube under argon. The reaction medium was heated with stirring at 185° C. for 30 min. After partial cooling (about 100° C.), compound A₁ (1 eq.) was added.

The reaction mixture was then heated at 215° C. for 2 hours. The reaction progress was monitored by HPLC, MS and NMR.

It was thus shown that the desired product M₁ was obtained almost quantitatively in a time of 2 hours after the end of the addition of compound A₁.

The obtained residue was worked up by extraction with chloroform. After filtering off the insoluble matter from the product and evaporating off the chloroform, the crude product was then purified by washing with methanol (and could alternatively or additionally be crystallized from toluene).

The pure product M₁ (structure confirmed by NMR and MS) was obtained in the form of white crystals in a yield of about 93% and a purity strictly greater than 99.5%, measured by NMR. The measured melting point was 212° C.

The use of t-BuOK as a base to deprotonate the phenol results in the production of tert-butanol (t-BuOH), which serves as solvent and facilitates total conversion. The second advantage of this base is that it allows the recovery/recycling of the alcohol on conclusion of the reaction by simple distillation.

### Example 12

### M₂ from A₂ with a Potassium Alkoxide as Base (Invention)

In a similar manner to that of Example 11, compound M₂ was obtained from compound A₂ under conditions similar to those described for the synthesis of M₁, with compound A₂ replacing compound A₁. A difference should be noted, however, regarding the work-up step: the crude product was extracted with acetone instead of chloroform.

The desired product M₂ was obtained almost quantitatively in a time of 2 hours after the end of the addition of compound A₂ (reaction progress monitored by NMR).

The pure product M₂ (structure confirmed by NMR and MS) was obtained in the form of white crystals in a yield of 92% and a purity strictly greater than 99.5% in HPLC. The measured melting point was about 132° C.-133° C.

### Example 13

### M₁/M₁″ mixture from A₃ as a Dilute Reaction Mixture (Comparative)

To synthesize compound M₁ from compound A₃, the process was performed substantially as in the reaction of Example 5, with A₃ replacing A₁. The following conditions were used: A₃ (1.9 mmol; 1 eq.), phenol (2 eq.) and potassium carbonate (2 eq.). The solvent used was a mixture of toluene (5 mL)/NBP (5 mL).

The reaction mixture was heated (after distilling off the toluene) at 200° C. for 24 hours (instead of 160° C. for 2 hours for the fluoro derivative).

The residue obtained was worked up by addition of methanol followed by evaporation under vacuum on a rotary evaporator until the NBP was removed (azeotrope).

The expected product M₁ detected by MS (about 70%) was obtained as a mixture with the starting material and the monophenoxy derivative (surface area ratio of about 15%) of formula M₁″:

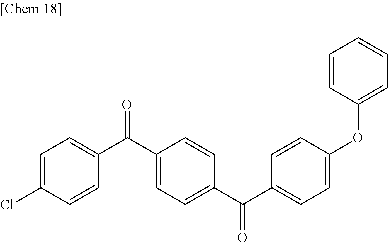 [SMILES: O=C(c1ccc(Cl)cc1)c1ccc(C(=O)c2ccc(Oc3ccccc3)cc2)cc1]

These results show that the conversion was not complete despite the increase in temperature and the extension of the heating time. The expected pure product M₁ was obtained after crystallization of the crude product from toluene, in a yield of 57% and a purity strictly greater than 99%, as measured by NMR. The measured melting point was 211° C.

### Example 14

### M₂/M₂″ Mixture from A₄ as a Dilute Reaction Mixture (Comparative)

In a similar manner to that of Example 13, compound M₂ was obtained from compound A₄ under conditions similar to those described for the synthesis of M₁, with compound A₄ replacing compound A₃.

The crude product was obtained as a mixture with the monophenoxy derivative M₂″ detected by MS (area ratio of about 15%) of formula:

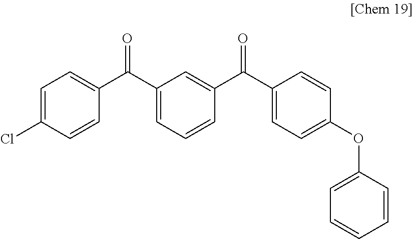 [SMILES: O=C(c1ccc(Cl)cc1)c1cccc(C(=O)c2ccc(Oc3ccccc3)cc2)c1]

and traces of starting materials (confirmed by NMR and MS).

After crystallization of the crude product from methanol, the pure product M₂ (structure confirmed by NMR and MS) was obtained in the form of a white solid in a yield of about 55% and a purity strictly greater than 99%. The recrystallized product has a measured melting point of: 132° C.

### Example 15

### M₁ from A₃ as a Concentrated Solution (Invention)

To synthesize compound M₁ from compound A₃, the process was performed in a similar manner to the reaction of Example 7, with A₃ replacing A₁. The following conditions were used: A₃ (1 mmol; 1 eq.), phenol (2.8 eq.) and anhydrous potassium bicarbonate (2.8 eq.). The solvent used was NBP (0.2 mL).

The reaction mixture was heated at 220° C. for 3 hours. The reaction progress was monitored by HPLC, MS and NMR. It was thus shown that the conversion to the desired product was almost quantitative at a time of 3 hours after the end of the addition of compound A₃. The work-up of the crude product was performed in the same manner as in Example 7.

The pure product M₁ (structure confirmed by NMR and MS) was obtained in the form of white crystals in a yield of 82% and a purity strictly greater than 99.5%, measured by NMR. The measured melting point was 211° C.

### Example 16

### M₂ from A₄ as a Concentrated Solution (Invention)

The procedure was exactly as in the case of the synthesis of Example 15, except that A₄ replaced A₃, the reaction mixture was heated to 210° C. instead of 220° C., and the crude product was extracted with acetone instead of chloroform. The pure product M₂ (structure confirmed by NMR and MS) was obtained in the form of white crystals in a yield of 82% and a purity of greater than or equal to 99.5%, as measured by NMR. The measured melting point was 133° C.

### Example 19

### M₁ from A₃ with A Potassium Alkoxide as Base (Invention)

Phenol (2.3 eq.) and then t-BuOK (2.2 eq.) were introduced into a sealed tube under argon. The reaction medium was heated with stirring at 185° C. for 30 min. After partial cooling (about 100° C.), compound A₃ (1 eq.) was added.

The reaction mixture was then heated at 220° C. for 3 hours. The reaction progress was monitored by HPLC and NMR. Thus, it was shown that the desired product M₁ was obtained almost quantitatively at a time of 3 hours after the end of the addition of compound A₃.

The residue obtained was extracted with chloroform. After filtering off the insoluble matter and evaporating off the chloroform, the crude product (relatively pure by NMR) was then crystallized from toluene.

The pure product M₁ (structure confirmed by NMR and MS) was obtained in the form of white crystals in a yield of 90% and a purity strictly greater than 99.5%, measured by NMR. The measured melting point was 212° C.

### Example 20

### M₂ from A₄ with a Potassium Alkoxide as Base (Invention)

The procedure was exactly as in the case of the synthesis of Example 19, except that A₄ replaced A₃, that the reaction mixture was heated to 205° C. instead of 220° C. and that for the work-up step, the crude product was extracted with acetone instead of chloroform.

The desired product M₂ was obtained almost quantitatively in a time of 2 hours after the end of the addition of compound A₂, which was confirmed by NMR. The pure product M₂ (structure confirmed by NMR and MS) was obtained in the form of white crystals in a yield of 90% and a purity strictly greater than 99.5%, measured by HPLC. The measured melting point was 132° C.

### Examples 21-24

### Influence of the Alkoxide Counterion t-BuO⁻

Experiments similar to those of Examples 11, 12, 19 and 20 were performed, in which t-BuONa was used instead of t-BuOK. They were entitled Examples 21, 22, 23 and 24, respectively. The reaction times and reaction temperatures were adapted so as to obtain virtually quantitative conversions. The conditions used and the results obtained are collated in Table 1 below:

TABLE 1

| | | | Yield of |
|---|---|---|---|
| | Temperature | Reaction time | purified |
| | (° C.) | (h) | product |
| Example 21 | 220 | 4 | >90 |
| Example 22 | 210 | 3 | >90 |
| Example 23 | 225 | 20 | >90 |
| Example 24 | 225 | 20 | >90 |

Thus, comparison of Examples 11, 12, 19, and 20 relative to Examples 21, 22, 23, and 24 shows that the reaction with t-BuOK is much faster kinetically than the reaction with t-BuONa, the reactions taking place in t-BuOH/excess phenol acting as a solvent.

### Example 25

### M₁ from A₁ with a Potassium Alkoxide as Base and Removal of the Alcohols Before Reaction

Phenol (2.3 eq.) and t-BuOK (2.2 eq.) were introduced into a sealed tube under argon. The reaction medium was heated at 185° C. (bath temperature) for 30 min. After partial cooling (to about 100° C.), the t-BuOH formed as by-product and also the excess phenol were removed by evaporation using a stream of nitrogen or argon. Compound A₁ was then added.

After total addition of compound A₁, the reaction mixture was heated at 230° C. (bath temperature) for 1 hour. From T=210° C. (bath temperature), it was noted that the reaction medium turned into a light brown, easily stirred suspension. The reaction progress was monitored by NMR. Thus, it could be shown that the conversion to the expected product M₁ was complete at a time of one hour after the end of the addition of compound A₁.

After cooling, the crude product formed in the form of a light brown solid was scraped and then ground. To remove the formed salts and any traces of phenol, the obtained crude product was stirred in distilled water (20 mL) for 1 hour, and then filtered and washed several times with distilled water and finally with pentane. After drying in an oven at 75° C. for 2 hours, the expected product M₁ was obtained in a yield of 94% in the form of an off-white powder with a purity strictly greater than 99.5% by NMR.

### Example 26

### M₁ from A₃ with a Potassium Alkoxide as Base and Removal of the Alcohols Before Reaction

Phenol (2.3 eq.) and t-BuOK (2.2 eq.) were introduced into a sealed tube. The reaction mixture was heated at 185° C. (bath temp.=185° C.) for 30 min. After partial cooling (to about 100° C.), the t-BuOH formed as by-product and also the excess phenol were removed by evaporation using a stream of nitrogen or argon. Compound A₃ was then added.

After total addition of compound A₃, the reaction mixture was heated at 230° C. for 4 hours. The reaction progress was monitored by NMR. Thus, it could be shown that the conversion was complete at a time of 4 hours after the end of the addition of compound A₃.

After cooling, the crude product formed in the form of a brown solid was stirred in distilled water (30 mL) for 6 hours. The resulting suspension was filtered and then washed several times with distilled water. After drying in an oven at 85° C. for 6 hours, the expected product M₁ was obtained in an excellent yield of about 93% in the form of an off-white powder, with a purity measured by NMR of strictly greater than 99.3%.

### Example 27

### M₂ from A₂ with a Potassium Alkoxide as Base and Removal of the Alcohols Before Reaction

The process was performed exactly as in the case of the synthesis of Example 26, except that A₂ replaced A₃. The experiment was performed under the following conditions: A₂ (3 mmol; 1 eq.); t-BuOK (0.748 g; 2.2 eq.); phenol (0.652 g; 2.3 eq.). After work-up using the process described in Example 26, compound M₂ was obtained in a yield of about 97%, with a purity measured by NMR strictly greater than 99.6%.

### Example 28

### M₁ from A₁ with a Sodium Alkoxide as Base and Removal of the Alcohols Before Reaction

The experiments were performed under the following conditions: HAr53 (3 mmol; 0.976 g; 1 eq.); t-BuONa (2.2 eq.); phenol (2.3 eq.).

Phenol (2.3 eq.) and t-BuONa (2.2 eq.) were introduced into a reactor equipped with a cold finger and a pressure gauge. The reaction medium was heated at 185° C. (bath temperature) for 30 min (internal temperature of 140° C.; internal pressure of 2.7 bar (pressure relative to atmospheric pressure). After partial cooling (to about 100° C.), the t-BuOH formed as by-product and also the excess phenol were removed by evaporation using a stream of nitrogen. Compound A₁ was then added.

After total addition of compound A₁, the reaction mixture was heated at 230° C. (bath temperature 230° C.; internal temperature 190° C.; internal pressure 0.25 bar) for 2 hours. It was noted that from an internal temperature of 170° C., the reaction mixture was in the form of a clear brown liquid and thus easily stirrable.

The reaction progress was monitored by NMR. It was thus proven that the conversion to the expected product M₁ was complete in a time of 2 hours after the end of the addition of A₁.

After cooling, the crude product formed in the form of a brown solid was stirred in distilled water (30 mL) for 6 hours. The resulting suspension was filtered and then washed several times with distilled water. After drying in an oven at 85° C. for 6 hours, the expected product M₁ was obtained in a yield of 96% in the form of an off-white powder with a purity strictly greater than 99.4%, measured by NMR.

By comparing Examples 19 and 28, it may be concluded that the reaction works just as well with t-BuONa as with t-BuOK in the absence of t-BuOH/excess phenol solvent.

### Example 29

### M₁ from A₃ with Sodium Metal as Base

Phenol (0.58 g; 2.2 eq.) and then dry THF (3 mL) were introduced into a reactor fitted with a cold finger and a thermometer. Sodium (2.2 eq.) was then added portionwise at 25° C. with vigorous stirring. Evolution of dihydrogen was observed. The reaction medium was stirred at 25° C. until the sodium had totally disappeared, over about 1 hour. The THF was then removed by evaporation by heating the reaction medium to 60° C. under a stream of nitrogen. After cooling, compound A₃ was added.

After total addition of compound A₃, the reaction mixture was heated at 230° C. (bath temperature) for 5 hours. It should be noted that from a measured internal temperature (temperature of the reaction mixture) of 190° C., the reaction medium changed into an easily stirred dark yellow liquid.

The reaction progress was monitored by NMR. Thus, it could be shown that the conversion to the expected product M₁ was about 65% in a time of 2 hours after the end of the addition of compound A₃, and was virtually total in a time of 5 hours after the end of the addition of compound A₃.

After cooling, the crude product obtained in the form of a brown solid was stirred in distilled water (30 mL) for 3 hours. The resulting suspension was filtered and then washed several times with distilled water. After drying in an oven at 85° C. for 6 hours, the expected product M₁ was obtained in a yield of 90% in the form of an off-white powder with a purity strictly greater than 99.3%, measured by NMR.

### Examples 30-32

### M₁ from A₃ with a Potassium Alkoxide as Base as a Concentrated Solution in DPS

In a sealed tube, phenol (2.4 eq.), anhydrous potassium carbonate in powder form (2.3 eq.), the monomer A₃ (1 eq., 0.2 g) and then diphenyl sulfone (DPS) in the form of a white solid (2.03 eq.) were introduced under argon. The reaction mixture was heated with stirring at 230° C. for 5 hours. After only 25 minutes, the reaction mixture turned dark red in the form of an easily stirred suspension. The reaction progress was monitored by NMR.

After cooling, the product obtained in the form of a white to off-white solid was purified by a first wash with acetone to remove the DPS and the excess phenol, followed by a second wash with distilled water to remove the salts formed: notably KCl and the excess potassium phenoxide. After drying in an oven at 75° C. for 2 hours, the expected monomer M₁ was obtained in the form of a white powder, pure by NMR (>99%), in a yield of 96%.

It should be noted that the diphenyl sulfone used was only of technical grade (Sigma-Aldrich; purity strictly greater than 97%).

The process was performed exactly as in the case of the synthesis of Example 30, with different proportions of starting compounds for Examples 31 and 32.

In Example 31, phenol (2.4 eq.), anhydrous potassium carbonate in powder form (2.3 eq.), the monomer A₃ (1 eq., 0.2 g) and then diphenyl sulfone (DPS) in the form of a white solid (4.07 eq.) were introduced into a sealed tube under argon. After two successive washes and drying, the expected monomer M₁ was obtained in the form of a white powder, which was pure by NMR (>99%), in a yield of 97%.

In Example 32, phenol (2.3 eq.), anhydrous potassium carbonate in powder form (2.2 eq.), the monomer A₃ (1 eq., 0.2 g) and then diphenyl sulfone (DPS) in the form of a white solid (4.07 eq.) were introduced into a sealed tube under argon. After two successive washes and drying, the expected monomer M₁ was obtained in the form of a white powder, which was pure by NMR (>99%), in a yield of 96%.

1. A process for manufacturing an aromatic diether, comprising the reaction of a compound A comprising at least two halogenated aromatic groups with a compound B, B being an aromatic alkoxide, optionally in the presence of a compound C acting as reaction solvent, the molar proportion of compound B to compound A being at least 2:1 and the molar amount of compound C to compound A being, where appropriate, not more than 10:1.

2. The manufacturing process as claimed in claim 1, in which compound A is a compound having the chemical formula:
X₁—Ar—[ZᵢArᵢ]ₙ—X₂ (II),
in which:
i is an integer ranging from 2 to 3, and n is an integer equal to 0 or 1;
X₁ and X₂ independently denote a halogen atom;
Ar and, for any i, Arᵢ independently denote a substituted or unsubstituted divalent aromatic group;
1,4-naphthylene, 1,5-naphthylene and 2,6-naphthylene; and
for any i, Zᵢ independently denotes an oxygen atom, a sulfur atom, an alkylene group, a carbonyl group or a sulfonyl group.

3. The manufacturing process as claimed in claim 2, in which, in the chemical formula (II):
i is equal to 2 and n is equal to 1;
X₁ and X₂ both denote a chlorine atom or a fluorine atom;
Ar and Ar₂ both denote a 1,4-phenylene group;
Ar₁ denotes a 1,3-phenylene or 1,4-phenylene group; and
Z₁ and Z₂ both denote a carbonyl group.

4. The manufacturing process as claimed in claim 1, in which compound B has the chemical formula:
Ar′—O⁻ (III),
in which:
Ar′ denotes a substituted or unsubstituted monovalent aromatic group.

5. The manufacturing process as claimed in claim 1, in which compound B is phenoxide.

6. The process as claimed in claim 1, in which the molar proportion of compound B to compound A is less than or equal to 3:1.

7. The manufacturing process as claimed in claim 1, in which compound B is obtained by deprotonation of the aromatic alcohol B″, the conjugate acid of the aromatic alkoxide B, with a base reacted with B″, in situ or ex situ, to give compound B.

8. The manufacturing process as claimed in claim 7, in which said base reacted with B″ is a linear or branched alkoxide salt comprising from 3 to 10 carbon atoms.

9. The manufacturing process as claimed in claim 7, in which said base reacted with B″ is a carbonate salt.

10. The manufacturing process as claimed in claim 7, in which said base reacted with B″ is an alkali metal salt.

11. The manufacturing process as claimed in claim 7, in which said base reacted with B″ is sodium metal or potassium metal.

12. The process as claimed in claim 7, in which the molar proportion of said base reacted with B″ relative to B″ is less than or equal to 1:1.

13. The manufacturing process as claimed in claim 1, in which compound C has a polarity measured at 20° C. of greater than or equal to 3 Debyes.

14. The manufacturing process as claimed in claim 1, in which compound C is chosen from the list consisting of: C1-C6-alkyl-2-pyrrolidones, sulfoxides, sulfones, nitriles, N dimethylamides,
and a mixture thereof.

15. The process as claimed in claim 1, in which the molar proportion of compound C to compound A is less than or equal to 7.5:1.

16. The process as claimed in claim 1, in which compound A is reacted with compound B, in the absence of any solvent.

17. The process as claimed in claim 1, in which compound A is reacted in molten form with compound B.

18. A process for manufacturing a polyaryl ether ketone polymer, comprising:
the manufacture of an aromatic diether as claimed in claim 1;
the reaction of said aromatic diether with a compound D comprising at least two acyl chloride groups.

19. The process as claimed in claim 18, in which compound D is a compound having the chemical formula:
ClC(O)—Ar—[Zⱼ—Arⱼ]ₘ—C(O)Cl (IV),
in which:
j is an integer ranging from 1 to 3 and m is an integer equal to 0 or 1;
Ar and, for any j, Arⱼ independently denote a substituted or unsubstituted divalent aromatic group; and,
for any j, Zj independently denotes an oxygen atom, a sulfur atom, an alkylene group, or a sulfone.

20. The process as claimed in claim 18, in which:
said aromatic diether is chosen from the list consisting of: 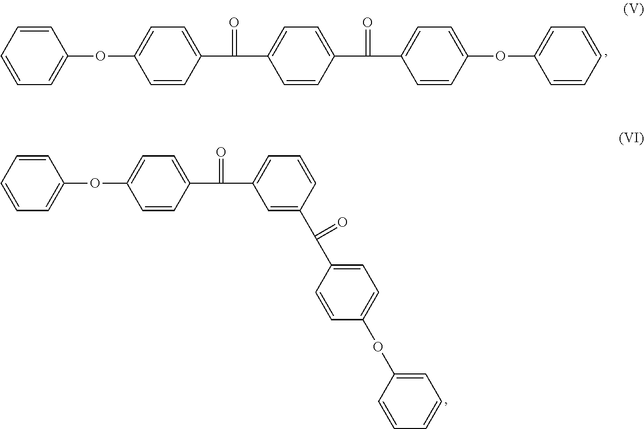 [SMILES: O=C(c1ccc(Oc2ccccc2)cc1)c1ccc(C(=O)c2ccc(Oc3ccccc3)cc2)cc1 ; O=C(c1ccc(Oc2ccccc2)cc1)c1cccc(C(=O)c2ccc(Oc3ccccc3)cc2)c1]
or a mixture thereof;
said compound D is chosen from the list of compounds consisting of: 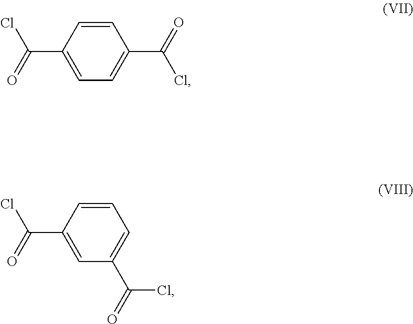 [SMILES: O=C(Cl)c1ccc(C(=O)Cl)cc1 ; O=C(Cl)c1cccc(C(=O)Cl)c1]
or a mixture thereof.

21. The process as claimed in claim 14, in which compound C is diphenyl sulfone.
